(19) United States
(12) Patent Application Publication
(10) Pub. No.: US 2026/0366411 A1
(43) Pub. Date: Nov. 19, 2026

(54) COLLABORATIVE WEAKENING METHOD OF HIGH AND LOW POSITIONS FOR HARD ROCK LAYER ROOF BASED ON DISCONTINUOUS FRACTURING

(71) Applicant: Anhui University of Science and Technology, Huainan (CN)

(72) Inventors: Lei Fan, Wuhu (CN); Jucai Chang, Huainan (CN); Tuo Wang, Nanyang (CN); Zhiqiang Yin, Hefei (CN); Hualei Zhang, Huainan (CN); Lianghuan Yan, Shangrao (CN); Haoran Chen, Hefei (CN)

(21) Appl. No.: 19/722,722

(22) Filed: Jun. 27, 2026

Related U.S. Application Data
(63) Continuation of application No. PCT/CN2026/075624, filed on Jan. 29, 2026.

(30) Foreign Application Priority Data
Jan. 29, 2025 (CN) 202511413219.9

(51) Int. Cl. E21B 43/263; G06F 17/11

(52) U.S. Cl. CPC E21B 43/263; G06F 17/11

(57) ABSTRACT

Provided is a collaborative weakening method of high and low positions for hard rock layer roof based on discontinuous fracturing, which includes obtaining rock stratum parameters of a benchmark area and rock stratum parameters of a current area; dividing a roadway into multiple independent sections based on the rock stratum parameters of the benchmark area and rock stratum parameters of the current area; drilling several sets of fracturing boreholes in each independent section, each set of fracturing boreholes consisting of a high-position deep hole and a low-position shallow hole; arranging the high-position deep hole and low-position shallow hole alternately along a tunnel axis according to the weakened unit length and rock bridge unit length; when detonating the fracturing boreholes, a detonation time of the high-position deep hole is delayed compared to a detonation time of the low-position shallow hole.

### CROSS-REFERENCE TO RELATED APPLICATIONS

This application is a continuation of International Application No. PCT/CN2026/1075624, filed on Jan. 29, 2026, which claims priority to Chinese Patent Application No. 202511413219.9, filed on Sep. 29, 2025, which is hereby incorporated by reference in its entirety.

### TECHNICAL FIELD

The present disclosure relates to the field of coal mining technologies, and in particular, to a collaborative weakening method of high and low positions for hard rock layer roof based on discontinuous fracturing.

### BACKGROUND

Hard rock layer roofs generally have the characteristics of very large thickness, particularly high strength, excellent overall integrity, and extremely strong self-stabilization ability. There are already many control methods for hard rock layer roofs, including hydraulic fracturing, presplitting cutting, ground fracturing and other technologies, which play a key role in solving the problem of suspended roofs.

However, due to the key shortcomings of traditional hard rock layer roof control technology: firstly, relying on a single drilling parameter is difficult to adapt to the significant differences in high and low hard rock layers, that is, it cannot ensure the formation of a short cantilever beam after cutting to achieve good pressure relief effect, and cannot guarantee that the cutting surface exceeds the anchorage zone of the roadway to minimize the impact of cutting on the stability of the surrounding rock of the roadway. Secondly, although the continuous dense roof cutting technology used to promote collapse is effective, the total number of boreholes is large, and the number of explosives consumed is high. The blasting vibration is prone to damage the surrounding rock structure and support system of the roadway, and frequent disturbances further deteriorate the long-term stability of the roadway surrounding rock. Furthermore, static design methods ignore the dynamic changes in roof lithology, often resulting in a deviation of the preset cutting position and incomplete or missed cutting of hard rock layers. The specific manifestation is that large angle drilling is limited by length and sealing requirements, making it difficult to cut through low position hard rocks, and excessive angles shorten the horizontal safety distance between the charging point and the roadway, threatening the stability of the roadway; however, small angle drilling requires ultra long construction to cut high position thick hard rock, resulting in poor pressure relief effect of the cantilever being too long after cutting. Although there have been attempts at layered drilling, the collaborative fracturing effect of high and low positions hard rock layer roofs is poor due to the lack of quantitative control mechanisms for safe deviation of charging points and the design concept of utilizing stress synergy between discontinuous fractured rock blocks.

Therefore, it is urgent to develop a new type of roof cutting technology that integrates dynamic adaptation of lithology, collaborative fracturing of high and low poisons hard rocks, and efficient utilization of natural rock bridges to achieve efficient pressure relief of the roof while ensuring the safety of the roadway.

### SUMMARY

In order to solve the above technical problems, the present disclosure proposes a collaborative weakening method of high and low positions for hard rock layer roof based on discontinuous fracturing.

The present disclosure is implemented by the following technical solutions.

A collaborative weakening method of high and low positions for hard rock layer roof based on discontinuous fracturing, including:
obtaining rock stratum parameters of a benchmark area and rock stratum parameters of a current area;
dividing a roadway into multiple independent sections based on the rock stratum parameters of the benchmark area and rock stratum parameters of the current area;
drilling several sets of fracturing boreholes in each independent section, each set of fracturing boreholes consisting of a high-position deep hole and a low-position shallow hole;
obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length;
when detonating the fracturing boreholes, a detonation time of the high-position deep hole is delayed compared to a detonation time of the low-position shallow hole, with a delay time, t_{delay}≥50 ms.

By adopting the above technical solution, the area with small differences in hard rock stratum parameters in the roadway is dynamically divided into independent sections, and low-position shallow holes and high-position deep holes are drilled in the independent sections. Through the coordinated cooperation of low-position shallow hole and high-position deep hole, the low-position hard rock and high-position hard rock of the roadway's hard rock layer roof plate are cut off in a targeted manner. At the same time, the spatial structure of alternately arranged low-position shallow hole and high-position deep hole is constructed, and a discontinuous fracturing structure of weakened unit—rock bridge unit is constructed. By using the gravity—mining stress coupling effect, the rock bridge unit collapses autonomously in a discontinuous fracturing mode, reducing the drilling amount of fracturing boreholes, thereby reducing explosive consumption, and avoiding an impact of huge blasting energy generated during continuous roof cutting on an own stability the surrounding rock of the roadway.

The collaborative weakening method of high and low positions for hard rock layer roof based on discontinuous fracturing as described above, where obtaining rock stratum parameters of a benchmark area and rock stratum parameters of a current area, includes:
drilling and observing from a beginning section of the tunnel to obtain the rock stratum parameters of the benchmark area;
starting from the starting section of the tunnel, drilling and observing are conducted every 30 meters to obtain multiple sets of rock stratum parameters of the current area.

The collaborative weakening method of high and low positions for hard rock layer roof based on discontinuous fracturing as described above, where the rock stratum parameters of the benchmark area include a depth

$${H}_{1}^{0}$$

of a low-position hard rock layer roof in the benchmark area, a thickness

$${T}_{1}^{0}$$

of a low-position hard rock layer in the benchmark area, a depth

$${H}_{2}^{0}$$

of a high-position hard rock layer roof in the benchmark area, and a thickness

$${T}_{2}^{0}$$

of a high-position hard rock layer in the benchmark area;
the rock stratum parameters of the current area include a depth

$${H}_{1}^{i}$$

from a center of the low-position hard rock to the roof in the current area, a thickness

$${T}_{1}^{i}$$

of the low-position hard rock layer in the current area, a depth

$${H}_{2}^{i}$$

from a center of the high-position hard rock to the roof in the current area, and a thickness

$${T}_{2}^{i}$$

of the high-position hard rock layer in the current area.

The collaborative weakening method of high and low positions for hard rock layer roof based on discontinuous fracturing as described above, where dividing a roadway into multiple independent sections based on the rock stratum parameters of the benchmark area and rock stratum parameters of the current area, include:
calculating a deviation rate

$$Δ {H}_{1}^{i}$$

of a center depth of a low-position hard rock, and a calculation formula is:

$$Δ {H}_{1}^{i} = \vert {H}_{1}^{i} - {H}_{1}^{0} \vert / {H}_{1}^{0} \times 100 \% ;$$

calculating a deviation rate

$$Δ {H}_{2}^{i}$$

of a center depth of a high-position hard rock, and a calculation formula is:

$$Δ {H}_{2}^{i} = \vert {H}_{2}^{i} - {H}_{1}^{0} \vert / {H}_{2}^{0} \times 100 \% ;$$

calculating a relative deviation rate

$$Δ {T}_{1}^{i}$$

of a thickness of the low-position hard rock, and a calculation formula is:

$$Δ {T}_{1}^{i} = \vert {T}_{1}^{i} - {T}_{1}^{0} \vert / {T}_{1}^{0} \times 100 \% ;$$

calculating a relative deviation rate

$$Δ {T}_{2}^{i}$$

of a thickness of the high-position hard rock, and a calculation formula is:

$$Δ {T}_{2}^{i} = \vert {T}_{2}^{i} - {T}_{2}^{0} \vert / {T}_{2}^{0} \times 100 \% ;$$

obtaining a relative change rate ΔK of lithological parameters according to the deviation rate

$$Δ {H}_{1}^{i}$$

of the center depth of the low-position hard rock, the deviation rate

$$Δ {H}_{2}^{i}$$

of the center depth of the high-position hard rock, the relative deviation rate

$$Δ {T}_{1}^{i}$$

of the thickness of the low-position hard rock, and the relative deviation rate

$$Δ {T}_{2}^{i}$$

of the thickness of the high-position hard rock, and a calculation process of the relative change rate ΔK of the lithological parameters is as follows:

$$Δ K = max ( Δ {H}_{1}^{i} , Δ {H}_{2}^{i} , Δ {T}_{1}^{i} , Δ {T}_{2}^{i} ) ,$$

if the relative change rate ΔK of the lithological parameters is less than a preset threshold, it is divided into an independent section.

The collaborative weakening method of high and low positions for hard rock layer roof based on discontinuous fracturing as described above, where drilling several sets of fracturing boreholes in each independent section, includes:
setting a drilling angle θ₁ of the low-position shallow hole and a drilling angle θ₂ of the high-position deep hole;
obtaining a hole depth length L₁ of the low-position shallow hole based on the drilling angle θ₁ of the low-position shallow hole and the depth

$${H}_{1}^{i}$$

form the center of the low-position hard rock layer to the roof in the current area, and a calculation process is as follows:

$${L}_{1} = \frac{{H}_{1}^{i}}{sin {θ}_{1}} ,$$

obtaining a hole depth length L₂ of the high-position deep hole based on the drilling angle θ₂ of the high-position deep hole and the depth

$${H}_{2}^{i}$$

from the center of the high-position hard rock layer to the roof in the current area, and a calculation process is as follows:

$${L}_{2} = \frac{{H}_{2}^{i}}{sin {θ}_{2}} .$$

The collaborative weakening method of high and low positions for hard rock layer roof based on discontinuous fracturing as described above, where setting a drilling angle θ₁ of the low-position shallow hole and a drilling angle θ₂ of the high-position deep hole, includes:
the drilling angle θ₁ of the low-position shallow hole being configured to meet a requirement that a sealing length F₁ of the low-position shallow hole is not less than one-third of the hole depth length L₁ of the low-position shallow hole;
the drilling angle θ₂ of the high-position deep hole being configured to meet a requirement that a sealing length F₂ of the high-position deep hole is not less than one-third of the hole depth length L₂ of the high-position deep hole.

The collaborative weakening method of high and low positions for hard rock layer roof based on discontinuous fracturing as described above, where setting a drilling angle θ₁ of the low-position shallow hole and a drilling angle θ₂ of the high-position deep hole, further includes:
the drilling angle θ₁ of the low-position shallow hole being configured to meet a requirement that a vertical projection position S₁ of a charging point of the low-position shallow hole is not less than an anchoring zone Lₐ of the roadway, that is:

S₁=F₁ cos θ₁≥Lₐ
the drilling angle θ₂ of the high-position deep hole being configured to meet a requirement that a vertical projection position S₂ of a charging point of the high-position deep hole is not less than the anchoring zone Lₐ of the roadway, that is:

S₂=F₂ cos θ₁≥Lₐ.

The collaborative weakening method of high and low positions for hard rock layer roof based on discontinuous fracturing as described above, where setting a drilling angle θ₁ of the low-position shallow hole and a drilling angle θ₂ of the high-position deep hole, further includes:
the drilling angle θ₁ of the low-position shallow hole being configured to meet a requirement that a low-position cantilever Lₓ₁ after cutting the low-position hard rock should be less than 10 m, and the low-position cantilever Lₓ₁ is:

Lx₁=L₁×cos θ₁
the drilling angle θ₂ of the high-position deep hole being configured to meet a requirement that a high-position cantilever Lₓ₂ after cutting the high-position hard rock should be less than 10 m, and the high-position cantilever Lₓ₂ is:

Lx₂=L₂×cos θ₂.

The collaborative weakening method of high and low positions for hard rock layer roof based on discontinuous fracturing as described above, where obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length, includes:
obtaining the weakened unit length Lᵣ based on the explosive fracturing radius R_{z}, the weakened unit length Lᵣ is twice the explosive fracturing radius R_{z};
obtaining the rock bridge unit length L_{b} based on the weakened unit length Lᵣ, the rock bridge unit length L_{b} is 1-1.5 times the weakened unit length Lᵣ;
setting a spacing L_{w} between adjacent sets of fracturing boreholes based on the explosive fracturing radius R_{z} and the rock bridge unit length L_{b}:

L_{w}=R_{z}+L_{b}.

The collaborative weakening method of high and low positions for hard rock layer roof based on discontinuous fracturing as described above, where obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length, further includes:
setting a distance Lₙ between the high-position deep hole and the low-position shallow hole in the same set of fracturing boreholes as the explosive fracturing radius R_{z}.

Compared with existing technologies, the present disclosure proposes a collaborative weakening method of high and low positions for hard rock layer roof based on discontinuous fracturing, which has the following beneficial effects.
1. The collaborative weakening method of high and low positions for hard rock layer roof proposed by the present disclosure dynamically divides the area with small differences in hard rock layer parameters in the roadway into independent sections, and drills low-position shallow holes and high-position deep holes in the independent sections; through the coordinated cooperation of low-position shallow hole and high-position deep hole, the low-position hard rock and high-position hard rock of the roadway's hard rock layer roof plate are cut off in a targeted manner. At the same time, the spatial structure of alternately arranged low-position shallow hole and high-position deep hole is constructed, and a discontinuous fracturing structure of weakened unit—rock bridge unit is constructed. By using the gravity—mining stress coupling effect, the rock bridge unit collapses autonomously in a discontinuous fracturing mode, reducing the drilling amount of fracturing boreholes, thereby reducing explosive consumption, and avoiding an impact of huge blasting energy generated during continuous roof cutting on an own stability the surrounding rock of the roadway.
2. The collaborative weakening method of high and low positions for hard rock layer roof proposed by the present disclosure can better adapt to the significant differences in high and low positions hard rock layers compared to traditional single drilling designs; the drilling angles and depths of low and high position shallow/deep holes can be designed separately according to the position and characteristics of high and low position hard rock layers, thereby better preventing the problem of incomplete or excessive roof cutting, ensuring that hard rock layers at different positions can be effectively cut, and through reasonable drilling angle design, the impact on the stability of the surrounding rock of the roadway during roof cutting can be minimized to the greatest extent.

### BRIEF DESCRIPTION OF DRAWINGS

In order to provide a clearer explanation of the technical solution in the embodiments of the present disclosure, a brief introduction will be given to the accompanying drawings required for the description of the embodiments.

FIG. 1 is a flowchart of a collaborative weakening method of high and low positions for hard rock layer roof based on discontinuous fracturing of the present disclosure.

FIG. 2 is a schematic diagram of a fracturing structure of a weakened unit—rock bridge unit of the present disclosure.

FIG. 3 is an implementation schematic diagram of a roof cutting scheme of the present disclosures.

### DESCRIPTION OF EMBODIMENTS

In order to make the technical problems, technical solutions, and beneficial effects solved by the present disclosure clearer and more understandable, the present disclosure will be further described in detail with reference to the accompanying drawings and embodiments. It should be understood that specific embodiments described herein are only used to explain the present disclosure and are not intended to limit the present disclosure.

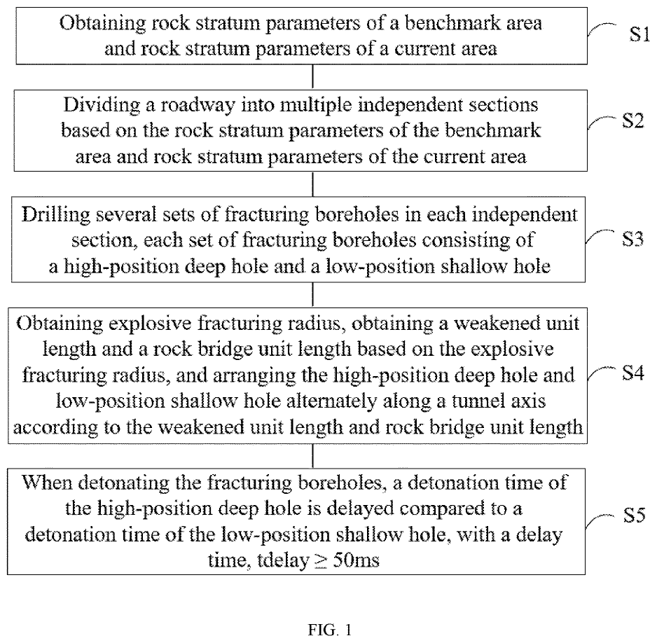

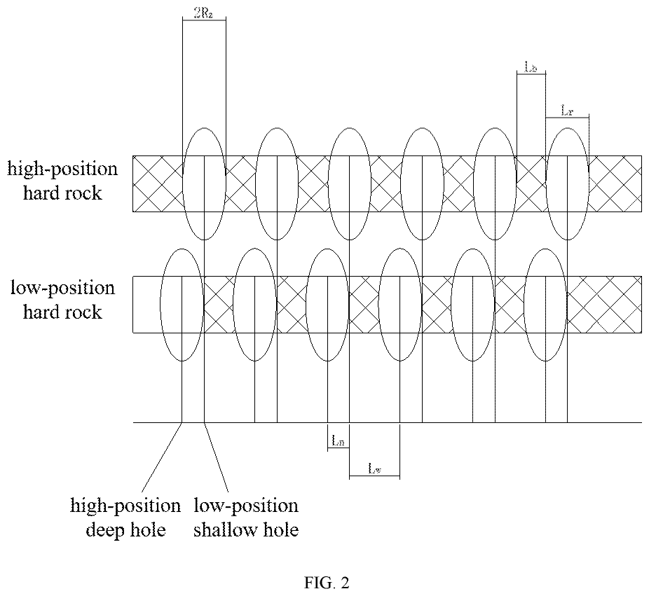

Referring to FIGS. 1 to 3, an embodiment of the present disclosure proposes a collaborative weakening method of high and low positions for hard rock layer roof based on discontinuous fracturing, including steps S1-S5,
S1: obtaining rock stratum parameters of a benchmark area and rock stratum parameters of a current area.

Specifically, the rock stratum parameters of the benchmark area include a depth

$${H}_{1}^{0}$$

of a low-position hard rock layer roof in the benchmark area, a thickness

$${T}_{1}^{0}$$

of a low-position hard rock layer in the benchmark area, a depth

$${H}_{2}^{0}$$

of a high-position hard rock layer roof in the benchmark area, and a thickness

$${T}_{2}^{0}$$

of a high-position hard rock layer in the benchmark area; the rock stratum parameters of the current area include a depth

$${H}_{1}^{i}$$

from a center of the low-position hard rock to the roof in the current area, a thickness

$${T}_{1}^{1}$$

of the low-position hard rock layer in the current area, a depth

$${H}_{2}^{i}$$

from a center of the high-position hard rock to the roof in the current area, and a thickness

$${T}_{2}^{i}$$

of the high-position hard rock layer in the current area;
where the depth of the low-position hard rock layer roof refers to a vertical distance from a roadway roof to an upper boundary of the low-position hard rock layer, and the depth of the high-position hard rock layer roof refers to a vertical distance from the roadway roof to an upper boundary of the high-position hard rock layer.

In an implementation mode of the present disclosure, step S1 includes steps S11-S12,
S11: drilling and observing from a beginning section of the tunnel to obtain the rock stratum parameters of the benchmark area;
S12: starting from the starting section of the tunnel, drilling and observing are conducted every 30 meters to obtain multiple sets of rock stratum parameters of the current area.

In an implementation mode, in the starting section or a first construction section of the tunnel, an area with stable geological conditions and no significant disturbance to lithological characteristics (such as the absence of faults, cracks, or fractured zones) is selected as the benchmark area; using a core drilling rig to drill a geological exploration hole with a diameter of 75 mm in this area, and then using the drilling imaging equipment to image and detect the geological exploration hole, measuring and obtaining the rock stratum parameters of the benchmark area;
starting from the starting section of the tunnel, a geological exploration hole with a diameter of 75 mm is drilled every 30 m along the tunnel direction; similarly, the drilling imaging equipment is used for imaging detection to measure and obtain the rock stratum parameters of a current rock layer of the current area, and so on; drilling and observing are carried out every 30 m to obtain multiple sets of rock layer parameters of the current area.

In this embodiment, by selecting an area with stable geological conditions and no obvious disturbance as the benchmark area, a unified and reliable reference standard is provided for the subsequent analysis of hard rock stratum parameters in the current area and the design of cutting schemes, thereby avoiding the unreasonable design of cutting schemes due to significant differences in reference standards, which may damage the long-term stability of the surrounding rock of the roadway.
S2: obtaining a relative change rate ΔK of lithological parameters based on the rock stratum parameters of the benchmark area and rock stratum parameters of the current area, and dividing the roadway into multiple independent sections according to the relative rate ΔK of the rock stratum parameters.

Specifically, the relative change rate ΔK of the lithological parameters is an indicator used to quantify a degree of differences in lithological parameters between different areas, reflecting the degree of change in the hard rock layers in the current area relative to a benchmark state. This embodiment compares and analyzes obtained multiple sets of rock stratum parameters in the current area with the rock stratum parameters in the benchmark area, and obtains the relative change rate ΔKᵢ of the rock stratum parameters in each current area; if the relative change rate ΔKᵢ of the rock stratum parameters in the current area is less than a preset relative change rate of the rock stratum parameters, it indicates that the difference between the hard rock stratum parameters in the current area and the hard rock stratum parameters in the benchmark area is small; therefore, it is divided into an independent section, and a same cutting scheme is adopted in each independent section;
if the relative change rate ΔKᵢ of the rock stratum parameters in a certain current area exceeds the preset relative change rate of the rock stratum parameters, it indicates that the hard rock stratum parameters in the current area have undergone significant changes, and therefore cannot be separately divided into independent sections. Instead, a suitable cutting plan needs to be redesigned for the hard rock stratum parameters in that area.

It should be noted that present values for the relative change rate of the lithological parameters mentioned above need to be comprehensively determined based on the performance of the explosives, the charge amount, the drilling design (such as drilling depth and angle), and the engineering requirements (such as the thickness of rock layers that need to be cut). Generally speaking, when the relative change rate of lithological parameters reaches a deviation of 15% to 25%, engineering personnel need to be highly vigilant. Therefore, in this embodiment, the preset relative change rate of lithological parameters is set to 20%.

In this embodiment, the area with small differences in hard rock stratum parameters is divided into independent sections based on the relative change rate of lithological parameters, and the same roof cutting scheme is adopted in each independent section, which helps to standardize the construction process, improve construction efficiency, and shorten the construction period.

In an implementation mode, step S2 includes steps S21 to S25,
S21: calculating a deviation rate

$$Δ {H}_{1}^{i}$$

of a center depth of a low-position hard rock, and a calculation formula is:

$$Δ {H}_{1}^{i} = \vert {H}_{1}^{i} - {H}_{1}^{0} \vert / {H}_{1}^{0} \times 100 \% ;$$

S22: calculating a deviation rate

$$Δ {H}_{2}^{i}$$

of a center depth of a high-position hard rock, and a calculation formula is:

$$Δ {H}_{2}^{i} = \vert {H}_{2}^{i} - {H}_{2}^{0} \vert / {H}_{2}^{0} \times 100 \% ;$$

S23: calculating a relative deviation rate

$$Δ {T}_{1}^{i}$$

of a thickness of the low-position hard rock, and a calculation formula is:

$$Δ {T}_{1}^{i} = \vert {T}_{1}^{i} - {T}_{1}^{0} \vert / {T}_{1}^{0} \times 100 \% ;$$

S24: calculating a relative deviation rate

$$Δ {T}_{2}^{i}$$

of a thickness of the high-position hard rock, and a calculation formula is:

$$Δ {T}_{2}^{i} = \vert {T}_{2}^{i} - {T}_{2}^{0} \vert / {T}_{2}^{0} \times 100 \% ;$$

S25: obtaining a relative change rate ΔK of lithological parameters according to the deviation rate

$$Δ {H}_{1}^{i}$$

of the center depth of the low-position hard rock, the deviation rate

$$Δ {H}_{2}^{i}$$

of the center depth of the high-position hard rock, the relative deviation rate

$$Δ {T}_{1}^{i}$$

of the thickness of the low-position hard rock, and the relative deviation rate

$$Δ {T}_{2}^{i}$$

of the thickness of the high-position hard rock, and a calculation process of the relative change rate ΔK of the lithological parameters is as follows:

$$Δ K = max ( Δ {H}_{1}^{i} , Δ {H}_{2}^{i} , Δ {T}_{1}^{i} , Δ {T}_{2}^{i} ) ,$$

if the relative change rate ΔK of the lithological parameters is less than a preset threshold, it is divided into an independent section.

By analyzing the rock stratum parameters of the current area of each set through steps S21 to S24, the deviation rate of the center depth and relative thickness of the low-position/high-position hard rock can be obtained. Based on the deviation rate of the center depth of the low-position/high-position hard rock, the degree of deviation of the spatial position of the hard rock layer in the current area relative to the depth of hard rock layer in the benchmark area can be reflected. Based on the relative thickness deviation rate of the low-position/high-position hard rock, the degree of change in the thickness of the hard rock layer in the current area relative to the thickness of the hard rock layer in the benchmark area can be reflected.

Besides that, due to excessive changes in the depth of the hard rock layer, it is easy for the cutting range to deviate from the target layer. If the thickness of the hard rock layer changes too much, it may not be able to bear the expected load. Therefore, in order to avoid the failure of the cutting plan caused by excessive changes in the depth or thickness of the current area, this embodiment takes the relative change rate of the rock stratum parameters in each current area as a maximum value of the deviation rate of the center depth of the low-position/high-position hard rock and the relative deviation rate of the thickness of the low-position/high-position hard rock in the current area, as a comprehensive judgment indicator, to ensure that the hard rock stratum parameters in each section are within the design safe and controllable range to the maximum extent possible.

In order to better understand this embodiment, it is assumed that a benchmark value

$${H}_{1}^{0}$$

for the depth of the low-position hard rock roof in the benchmark area is 10 m, and a benchmark value

$${T}_{1}^{0}$$

for the thickness of the low-position hard rock layer is 5 m. At the same time, the relative change rate ΔK of the low-position rock stratum parameters is set to 20% for example. Combined with the calculation formula for the deviation rate of the center depth of the low-position hard rock, it can be seen that a depth threshold from the center of the low-position hard rock to the roof in each current area is

$$\vert {H}_{1}^{i} - 10 \vert = 10 \times 20 \% .$$

Therefore, the range of

$${H}_{1}^{i}$$

is solved to be 9-11 m. That is to say, if the depth from the center of the low-position hard rock to the roof in the current area is less than 9 m or greater than 11 m, it indicates that a depth change of the low-position hard rock in the current area is too large. Based on the calculation formula for the relative deviation rate of the thickness of the low-position hard rock, it can be concluded that a thickness threshold for the low-position hard rock in each current area is

$$\vert {T}_{1}^{i} - 5 \vert = 5 \times 20 \% .$$

Therefore, a range of

$${T}_{1}^{i}$$

is obtained to be between 4-6 m; in other words, if the thickness of the low-position hard rock in the current area is less than 4 m or greater than 6 m, it indicates that the thickness change in the current area is too large;
similarly, based on the benchmark values of the high-position hard rock roof depth and high-position hard rock thickness in the benchmark area, the depth threshold values from the center of the high-position hard rock to the roof and high-position hard rock thickness for each current area can be obtained. As long as depth threshold values form the centers of the low-position/high-position hard rocks to the roofs in the current area exceed the threshold range, or the low-position/high-position hard rock thickness exceeds the threshold range, it can be judged that the rock layer in the current area have changed too much.
S3: drilling several sets of fracturing boreholes in each independent section, each set of fracturing boreholes consisting of a high-position deep hole and a low-position shallow hole.

Specifically, the fracturing borehole drilled in this embodiment adopts a dual hole design, which combines low-position shallow hole and high-position deep hole. Through the coordinated cooperation of low-position shallow hole and high-position deep hole, targeted cutting of low-position hard rock and high-position hard rock on the hard rock layer roof of the roadway can be achieved. Compared with the traditional single drilling design, it can better adapt to the significant differences between high-position and low-position hard rock layers, and the drilling angle and depth of low-position shallow holes/high-position deep holes can be designed separately according to the position and characteristics of high-position and low-position hard rock layers. This can better prevent the problem of incomplete or excessive cutting of the roof, ensure that hard rock layers at different positions can be effectively cut, and through reasonable drilling angle design, it can also minimize the impact of cutting on the stability of the surrounding rock of the roadway.

Besides that, when drilling fracturing boreholes, engineering designers first set the drilling angles for low-position shallow hole and high-position deep hole, and then verify whether set drilling angles meet requirements of a vertical projection of a charging point exceeding an anchorage zone of the roadway, whether a sealing length of low-position shallow holes is not less than ⅓ of a depth length of the low-position shallow hole, a sealing length of the high-position deep hole is not less than ⅓ of a hole depth length of the high-position deep hole, and whether a high-position cantilever after cutting the high-position hard rock should be less than 10 m, and a low-position cantilever after cutting the low-position hard rock should be less than 10 m. If any of these requirements are not met, it indicates that the current set drilling angle is unreasonable and the drilling angle for low-position shallow hole/high-position deep hole needs to be reset.

In this embodiment, the drilling angles of low-position shallow hole/high-position deep hole must meet a constraint that the vertical projection of the charging point exceeds the range of the roadway anchorage zone, in order to avoid the impact of blasting energy on the roadway support structure, which may cause support failure, and thus minimize the impact on the stability of the roadway surrounding rock during roof cutting; meeting the requirement that the sealing length of the hole should not be less than one-third of the depth of the hole is to prevent poor sealing effect caused by insufficient sealing length, which may lead to safety risks caused by gas leakage. At the same time, it also ensures the effective utilization of blasting energy and avoids energy waste; satisfying the cantilever length to be less than 10 m is to avoid shear failure or bending fracture caused by excessive cantilever length, as well as to prevent sudden roof collapse due to incomplete roof cutting and pressure relief caused by excessive cantilever length.

In an implementation mode, step S3 includes steps S31-S33:
S31: setting a drilling angle θ₁ of the low-position shallow hole and a drilling angle θ₂ of the high-position deep hole;
S32: obtaining a hole depth length L₁ of the low-position shallow hole based on the drilling angle θ₁ of the low-position shallow hole and the depth

$${H}_{1}^{i}$$

form the center of the low-position hard rock layer to the roof in the current area, and a calculation process is as follows:

$${L}_{1} = \frac{{H}_{1}^{i}}{sin {θ}_{1}}$$

S33: obtaining a hole depth length L₂ of the high-position deep hole based on the drilling angle θ₂ of the high-position deep hole and the depth

$${H}_{2}^{i}$$

from the center of the high-position hard rock layer to the roof in the current area, and a calculation process is as follows:

$${L}_{2} = \frac{{H}_{2}^{i}}{sin {θ}_{2}} .$$

Specifically, when drilling fracturing boreholes, engineering designers can first set the drilling angles for the low-position shallow hole and the high-position deep hole based on previous cutting plans or actual rock stratum parameters on the construction site. Then, according to the set drilling angles, the length of the hole depth to be drilled for the low-position shallow hole and the high-position deep hole can be calculated. Based on the calculated length of the hole depth and the set drilling angle, the rationality of the set drilling angle can be verified.

In an implementation mode, step S31 includes steps S311-S312:
S311: the drilling angle θ₁ of the low-position shallow hole being configured to meet a requirement that a sealing length F₁ of the low-position shallow hole is not less than one-third of the hole depth length L₁ of the low-position shallow hole;
S312: the drilling angle θ₂ of the high-position deep hole being configured to meet a requirement that a sealing length F₂ of the high-position deep hole is not less than one-third of the hole depth length L₂ of the high-position deep hole.

Specifically, the sealing length of the low-position shallow hole and the high-position deep hole refers to the use of sealing materials to seal borehole openings of the low-position shallow hole and the high-position deep hole before blasting, thereby preventing the leakage of blasting energy from the hole openings during blasting, ensuring that blasting energy is concentrated on the rock mass, improving blasting efficiency, and reducing hazards such as flying rocks and noise.

Where, for the sealing materials, special blasting sealing mud made by mixing clay, sand, and water in a certain proportion is generally used. Due to its dense texture and certain plasticity, this type of blasting mud can effectively block gas and blasting energy leakage, and is noncombustible, non-explosive, and has high safety. Therefore, it is also commonly used sealing material in this engineering field.

In an implementation mode, step 531 further includes steps S313-S314:
S313: the drilling angle θ₁ of the low-position shallow hole being configured to meet a requirement that a vertical projection position S₁ of a charging point of the low-position shallow hole is not less than an anchoring zone Lₐ of the roadway, that is:

S₁=F₁ cos θ₁≥Lₐ,
S314: the drilling angle θ₂ of the high-position deep hole being configured to meet a requirement that a vertical projection position S₂ of a charging point of the high-position deep hole is not less than the anchoring zone Lₐ of the roadway, that is:

S₁=F₁ cos θ₁≥Lₐ.

Specifically, the anchorage zone of the tunnel refers to an area where the surrounding rock (such as roof, sidewall, and floor) is reinforced through anchoring support structures such as anchor rods, anchor cables, and anchor nets to prevent deformation and collapse after excavation. The vertical projection position of the low-position shallow hole and high-position deep hole charging point should exceed the anchorage zone of the roadway, which means that there is a certain thickness of unanchored rock mass between the charging point and the anchorage support structure, that is, there is a buffer layer, which can prevent the blasting energy generated during blasting from directly acting on the anchorage support structure, thereby avoiding damage to the anchor rods, anchor cables or anchor nets, leading to the failure of the support structure, and thus reducing the stability of the roadway surrounding rock itself.

In an implementation mode, step S31 further includes steps S315-S316:
S315: the drilling angle θ₁ of the low-position shallow hole being configured to meet a requirement that a low-position cantilever Lₓ₁ after cutting the low-position hard rock should be less than 10 m, and the low-position cantilever Lₓ₁ is:

Lx₁=L₁×cos θ₁
S316: the drilling angle θ₂ of the high-position deep hole being configured to meet a requirement that a high-position cantilever Lₓ₂ after cutting the high-position hard rock should be less than 10 m, and the high-position cantilever Lₓ₂ is:

Lx₂=L₂×cos θ₂.

Specifically, low-position/high-position cantilever refers to the cantilever beam formed above the roadway roof by the remaining uncut hard rock after the hard rock layer is blasted and cut. Due to the significant increase in bending moment and shearing force of the cantilever beam with the length of the cantilever beam, in order to avoid the sudden collapse of the cantilever beam caused by stress concentration exceeding the shearing force and bending strength of the hard rock layer, the drilling angle of the low-position shallow hole and the high-position deep hole should ensure that the length of the low-position cantilever and the high-position cantilever is less than 10 m, so that the bending moment and shearing force of the hard rock layer cantilever are within a safe range, and avoid the sudden collapse of the cantilever rock block.

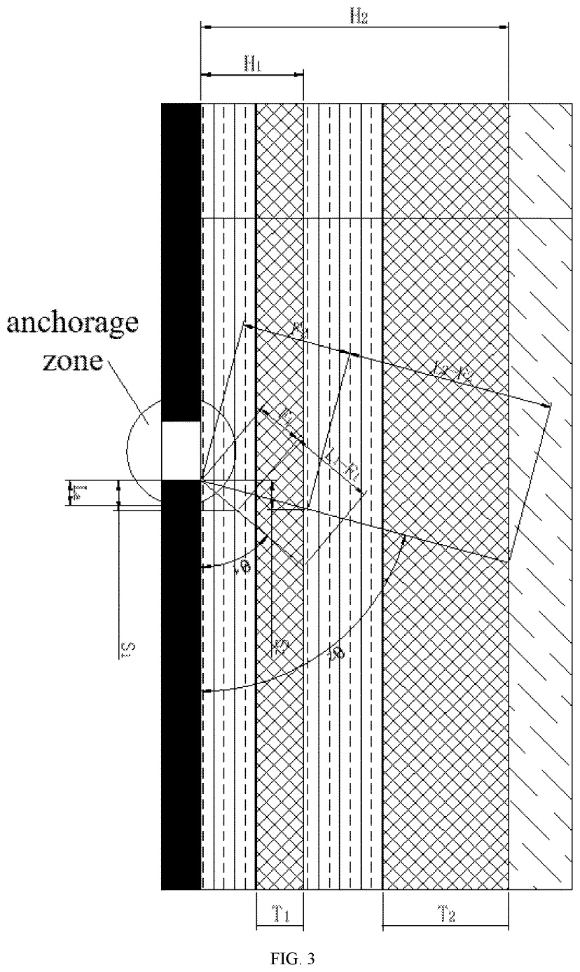

Referring to FIG. 3, this embodiment provides a schematic diagram of the roof cutting scheme to facilitate a better understanding of the above process, and a specific calculation process of this scheme is as follows:
firstly, according to the drilling imaging equipment, the depth H₁ form the center of the low-position hard rock layer to the roof in the current area is 13 m, the depth H₂ from the center of the high-position hard rock layer to the roof is 39 m, the thickness T₁ of the low-position hard rock layer in the current area is 6 m, and the thickness T₂ of the high-position hard rock layer in the current area is 16 m; at the same time, the drilling angle θ₁ of the low-position shallow hole is set to 60°, the drilling angle θ₂ of the high-position deep hole is set to 80°, and the anchoring zone Lₐ of the roadway in this embodiment is 2 m;
based on the parameters obtained above and combined with the set drilling angle, the drilling depth can be obtained; for the depth length L₁ of the low-position shallow hole, according to the calculation formula in step S32, it could be concluded as L₁=13/sin 60°=15.01; for the depth length L₂ of the high-position deep hole, according to the calculation formula in step S33, it could be concluded as L₂=39/sin 80°=39.60; according to the depth length of the low-position shallow hole and the depth length of the high-position deep hole, the sealing length of the low-position shallow hole that meets the sealing length condition can be obtained as F₁=L₁/3=5, and the sealing length of the high-position deep hole is F₂=L₂/3=13.20; according to the calculation in step S313, the vertical projection position of the charging point for the low position shallow hole is A₁=F₁ cos 60°=2.5; according to the calculation in step S314, the vertical projection position of the charging point for the high position deep hole is S₂=F₂ cos 80°=2.29; therefore, it can be concluded that the vertical projection positions of the charging points for the low position shallow hole and the high position deep hole are both greater than the anchorage zone of the tunnel; according to the calculation in step S315, the low-position cantilever of the low-position shallow hole is Lx₁=L₁×cos 60°=7.51; according to the calculation in step S316, the high-position cantilever of the high-position deep hole is Lx₂=L₂×cos 80°=6.87; therefore, it can be concluded that the low-position cantilever of the low-position shallow hole and the high-position cantilever of the high-position deep hole are both less than 10 m; therefore, the drilling angle setting of the low-position shallow hole and high-position deep hole is reasonable and meets the design requirements.

It is worth noting that if any of the above verification processes do not meet one of the design requirements, it proves that the drilling angle setting is unreasonable. At this time, the drilling angle needs to be reset and rechecked until the setting of the drilling angle meets all the constraints mentioned above.
S4: obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length.

Specifically, by obtaining the explosive fracturing radius, the length of the weakened unit and the length of the rock bridge unit are obtained. Based on these parameters, low-position shallow holes and high-position deep holes are arranged along the axial direction of the tunnel to construct a discontinuous fracturing structure of the weakened unit rock—bridge unit. Therefore, during blasting cutting, the weakened unit is subjected to the explosive fracturing effect to form a blasting weakening zone. As a part of the rock mass that is not directly damaged between adjacent blasting weakening zones, the rock bridge unit can avoid the impact of blasting energy on the surrounding rock and reduce the stability of the tunnel surrounding rock itself Δt the same time, due to the hard rock roof cutting, a working face is advanced by 100-200 m. When the working face advances to the roof cutting area, the rock layer in the roof cutting area is in the mining affected zone of the working face. At this time, the hard rock roof is strongly affected by mining stress, causing the original blasting weakened zone to further rupture and expand. The original unbroken rock bridge unit will also be damaged under the action of mining stress. When the working face pushes over the roof cutting area, the coal seam is mined out to form a goaf, and the overlying rock strata above it will collapse and fill the goaf under the action of gravity and mining stress. At this time, the broken rock bridge unit will also collapse. Compared to traditional continuous roof cutting methods, this non continuous roof cutting method reduces explosive consumption and avoids the impact of the huge blasting energy generated during continuous roof cutting on the stability of the surrounding rock of the roadway, as the setting of the rock bridge unit does not require drilling a large number of fracturing boreholes in the roadway.

It should be noted that the above-mentioned explosive fracturing radius refers to a range radius of effective rupture in the rock mass after explosive blasting. When measuring the explosive fracturing radius, blasting observation holes are generally arranged in advance. After using explosive blasting, the crack situation on the hole wall of the blasting observation hole is observed through drilling imaging equipment, and the maximum distance at which obvious through cracks appear in the blasting observation hole is taken as the explosive fracturing radius.

In an implementation mode, step S4 includes steps S41-S43:
S41: obtaining the weakened unit length Lᵣ based on the explosive fracturing radius R_{z}, the weakened unit length Lᵣ is twice the explosive fracturing radius R_{z};
S42: obtaining the rock bridge unit length L_{b} based on the weakened unit length Lᵣ, the rock bridge unit length L_{b} is 1-1.5 times the weakened unit length Lᵣ;
S43: setting a spacing L_{w} between adjacent sets of fracturing boreholes based on the explosive fracturing radius R_{z} and the rock bridge unit length L_{b}:

L_{w}=R_{z}+L_{b}.

Specifically, the weakened unit refers to the rock mass area that needs to be broken or fractured, that is, the pre splitting area generated during low-position shallow hole and high-position deep hole blasting (also known as the blasting weakening zone); in this embodiment, the length of the weakened unit is set to twice the explosive fracturing radius, in order to ensure that a single weakened unit can completely cover a range of a hard rock layer that needs to be cut or depressurized, and to avoid the inability to effectively release stress due to insufficient weakening length;
the rock bridge unit refers to a part of the rock mass between two adjacent blasting weakening zones that has not been directly damaged; its length and integrity will directly affect the blasting effect and rock stability; the length of the rock bridge unit is usually 1-1.5 times the length of the weakened unit; by setting an intact rock mass with a certain length, on the one hand, excessive weakening is prevented, and on the other hand, the impact of blasting energy on the surrounding rock mass is avoided, thereby reducing the stability of the tunnel surrounding rock itself.

In an implementation mode, step S4 also includes step S44:
S44: setting a distance Lₙ between the high-position deep hole and the low-position shallow hole in the same set of fracturing boreholes as the explosive fracturing radius R_{z}.

In this embodiment, the distance between the low-position shallow holes and high-position deep holes in the same set of fracturing boreholes is set as the explosive fracturing radius, so that the rupture boundary of the two boreholes just contacts to form a blasting weakening zone where the high-position hard rock layer and low-position hard rock layer cooperate with each other. At the same time, the rock bridge unit with a certain length is set between adjacent sets of fracturing boreholes, thus constructing a discontinuous fracturing structure of weakened unit—rock bridge unit. When the working face passes through the roof cutting area, the hard rock layer roof is strongly affected by mining stress, causing the original blasting weakening zone to further rupture and expand. The original unbroken rock bridge unit will also be destroyed under the action of mining stress so as to promote the autonomous fracture of the retained rock bridge units under the coupling effect of gravity—mining stress, compared to the continuous roof cutting method, due to the fact that the setting of the rock bridge unit does not require drilling a large number of fracturing boreholes in the roadway, it reduces the consumption of explosives and also avoids the impact of the huge blasting energy generated during continuous roof cutting on the stability of the surrounding rock of the roadway.
S5: when detonating the fracturing boreholes, a detonation time of the high-position deep hole is delayed compared to a detonation time of the low-position shallow hole, with a delay time, t_{delay}≥50 ms.

In this embodiment, the low-position shallow hole is preferentially detonated over the high-position deep hole, which will generate initial stress field waves and crack networks in the rock mass of the roadway, causing the low-position hard rock layer to first break, relieve pressure, and form a pre cracking zones with certain range. After a delay of 50 ms, the high-position deep hole is detonated. At this time, the stress field waves generated will superimpose with the residual stress field waves in the low-position pre cracking zone and guide and expand upwards along the already formed crack network in the low-position area, thus forming a continuous blasting weakening zone, avoiding the phenomenon of high and low-position fragmentation and discontinuous weakening.

Those skilled in the art should understand that the above description is an implementation mode provided in combination with specific content, and do not consider the specific implementation of the present disclosure to be limited to these descriptions. At the same time, due to different industry names, it is not limited to the above names, nor is it limited to English names. Any approximation or similarity to the method, structure, etc. of the present disclosure, or any technical deduction or substitution made under the premise of the inventive concept, should be considered as the protection scop of the present disclosure.

What is claimed is:

1. A collaborative weakening method of high and low positions for hard rock layer roof based on discontinuous fracturing, comprising:
obtaining rock stratum parameters of a benchmark area and rock stratum parameters of a current area;
dividing a roadway into multiple independent sections based on the rock stratum parameters of the benchmark area and rock stratum parameters of the current area;
drilling several sets of fracturing boreholes in each independent section, each set of fracturing boreholes consisting of a high-position deep hole and a low-position shallow hole;
obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length;
when detonating the fracturing boreholes, a detonation time of the high-position deep hole is delayed compared to a detonation time of the low-position shallow hole, with a delay time, t_{delay}≥50 ms;
wherein the rock stratum parameters of the benchmark area comprise a depth
$${H}_{1}^{0}$$
of a low-position hard rock layer roof in the benchmark area, a thickness
$${T}_{1}^{0}$$
of a low-position hard rock layer in the benchmark area, a depth
$${H}_{2}^{0}$$
of a high-position hard rock layer roof in the benchmark area, and a thickness
$${T}_{2}^{0}$$
of a high-position hard rock layer in the benchmark area;
the rock stratum parameters of the current area comprise a depth
$${H}_{1}^{i}$$
from a center of the low-position hard rock to the roof in the current area, a thickness
$${T}_{1}^{i}$$
of the low-position hard rock layer in the current area, a depth
$${H}_{2}^{i}$$
from a center of the high-position hard rock to the roof in the current area, and a thickness
$${T}_{2}^{i}$$
of the high-position hard rock layer in the current area.

2. The collaborative weakening method of high and low positions for hard rock layer roof based on discontinuous fracturing according to claim 1, wherein obtaining rock stratum parameters of a benchmark area and rock stratum parameters of a current area comprises:
drilling and observing from a beginning section of the tunnel to obtain the rock stratum parameters of the benchmark area;
starting from the starting section of the tunnel, drilling and observing are conducted every 30 meters to obtain multiple sets of rock stratum parameters of the current area.

3. The collaborative weakening method of high and low positions for hard rock layer roof based on discontinuous fracturing according to claim 1, wherein dividing a roadway into multiple independent sections based on the rock stratum parameters of the benchmark area and rock stratum parameters of the current area comprises:
calculating a deviation rate
$$Δ {H}_{1}^{i}$$
of a center depth of a low-position hard rock, and a calculation formula is:
$$Δ {H}_{1}^{i} = \vert {H}_{1}^{i} - {H}_{1}^{0} \vert / {H}_{1}^{0} \times 100 \% ;$$
calculating a deviation rate
$$Δ {H}_{2}^{i}$$
of a center depth of a high-position hard rock, and a calculation formula is:
$$Δ {H}_{2}^{i} = \vert {H}_{2}^{i} - {H}_{2}^{0} \vert / {H}_{2}^{0} \times 100 \% ;$$
calculating a relative deviation rate
$$Δ {T}_{1}^{i}$$
of a thickness of the low-position hard rock, and a calculation formula is:
$${ΔT}_{1}^{i} = \vert {T}_{1}^{i} - {T}_{1}^{0} \vert / {T}_{1}^{0} \times 100 \% ;$$
calculating a relative deviation rate
$$Δ {T}_{2}^{i}$$
of a thickness of the high-position hard rock, and
a calculation formula is:
$${ΔT}_{2}^{i} = \vert {T}_{2}^{i} - {T}_{2}^{0} \vert / {T}_{2}^{0} \times 100 \% ;$$
obtaining a relative change rate ΔK of lithological parameters according to the deviation rate
$$Δ {H}_{1}^{i}$$
of the center depth of the low-position hard rock, the deviation rate
$$Δ {H}_{2}^{i}$$
of the center depth of the high-position hard rock, the relative deviation rate
$$Δ {T}_{1}^{i}$$
of the thickness of the low-position hard rock, and the relative deviation rate
$$Δ {T}_{2}^{i}$$
of the thickness of the high-position hard rock, and a calculation process of the relative change rate ΔK of the lithological parameters is as follows:
$$Δ K = max ( Δ {H}_{1}^{i} , Δ {H}_{2}^{i} , Δ {T}_{1}^{i} , Δ {T}_{2}^{i} ) ,$$
if the relative change rate ΔK of the lithological parameters is less than a preset threshold, it is divided into an independent section.

4. The collaborative weakening method of high and low positions for hard rock layer roof based on discontinuous fracturing according to claim 1, wherein drilling several sets of fracturing boreholes in each independent section comprises:
setting a drilling angle θ₁ of the low-position shallow hole and a drilling angle θ₂ of the high-position deep hole;
obtaining a hole depth length L₁ of the low-position shallow hole based on the drilling angle θ₁ of the low-position shallow hole and the depth
$${H}_{1}^{i}$$
form the center of the low-position hard rock layer to the roof in the current area, and a calculation process is as follows:
$${L}_{1} = \frac{{H}_{1}^{i}}{sin {θ}_{1}} ,$$
obtaining a hole depth length L₂ of the high-position deep hole based on the drilling angle θ₂ of the high-position deep hole and the depth
$${H}_{2}^{i}$$
from the center of the high-position hard rock layer to the roof in the current area, and a calculation process is as follows:
$${L}_{2} = \frac{{H}_{2}^{i}}{sin {θ}_{2}} .$$

5. The collaborative weakening method of high and low positions for hard rock layer roof based on discontinuous fracturing according to claim 4, wherein setting a drilling angle θ₁ of the low-position shallow hole and a drilling angle θ₂ of the high-position deep hole comprises:
the drilling angle θ₁ of the low-position shallow hole being configured to meet a requirement that a sealing length F₁ of the low-position shallow hole is not less than one-third of the hole depth length L₁ of the low-position shallow hole;
the drilling angle θ₂ of the high-position deep hole being configured to meet a requirement that a sealing length F₂ of the high-position deep hole is not less than one-third of the hole depth length L₂ of the high-position deep hole.

6. The collaborative weakening method of high and low positions for hard rock layer roof based on discontinuous fracturing according to claim 5, wherein setting a drilling angle θ₁ of the low-position shallow hole and a drilling angle θ₂ of the high-position deep hole, further comprises:
the drilling angle θ₁ of the low-position shallow hole being configured to meet a requirement that a vertical projection position S₁ of a charging point of the low-position shallow hole is not less than an anchoring zone Lₐ of the roadway, that is:
S₁=F₁ cos θ₁≥Lₐ
the drilling angle θ₂ of the high-position deep hole being configured to meet a requirement that a vertical projection position S₂ of a charging point of the high-position deep hole is not less than the anchoring zone Lₐ of the roadway, that is:
S₂=F₂ cos θ₁≥Lₐ.

7. The collaborative weakening method of high and low positions for hard rock layer roof based on discontinuous fracturing according to claim 4, wherein setting a drilling angle θ₁ of the low-position shallow hole and a drilling angle θ₂ of the high-position deep hole, further comprises:
the drilling angle θ₁ of the low-position shallow hole being configured to meet a requirement that a low-position cantilever Lₓ₁ after cutting the low-position hard rock should be less than 10 m, and the low-position cantilever Lₓ₁ is:
Lx₁=L₁×cos θ₁
the drilling angle θ₂ of the high-position deep hole being configured to meet a requirement that a high-position cantilever Lₓ₂ after cutting the high-position hard rock should be less than 10 m, and the high-position cantilever Lₓ₂ is:
Lx₂=L₂×cos θ₂.

8. The collaborative weakening method of high and low positions for hard rock layer roof based on discontinuous fracturing according to claim 1, wherein obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length, comprise:
obtaining the weakened unit length Lᵣ based on the explosive fracturing radius R_{z}, the weakened unit length Lᵣ is twice the explosive fracturing radius R_{z};
obtaining the rock bridge unit length L_{b} based on the weakened unit length Lᵣ, the rock bridge unit length L_{b} is 1-1.5 times the weakened unit length Lᵣ;
setting a spacing L_{w} between adjacent sets of fracturing boreholes based on the explosive fracturing radius R_{z} and the rock bridge unit length L_{b}:
L_{w}=R_{z}+L_{b}.

9. The collaborative weakening method of high and low positions for hard rock layer roof based on discontinuous fracturing according to claim 8, wherein obtaining explosive fracturing radius, obtaining a weakened unit length and a rock bridge unit length based on the explosive fracturing radius, and arranging the high-position deep hole and low-position shallow hole alternately along a tunnel axis according to the weakened unit length and rock bridge unit length, further comprises:
setting a distance Lₙ between the high-position deep hole and the low-position shallow hole in the same set of fracturing boreholes as the explosive fracturing radius R_{z}.
